(19) United States
(12) Patent Application Publication
(10) Pub. No.: US 2018/0258278 A1
(43) Pub. Date: Sep. 13, 2018

(54) Low Emission, Wear Resistant Polyoxymethylene Composition

(71) Applicant: Celanese Sales Germany GmbH, Sulzbach (DE)

(72) Inventors: Qamer Zia, Raunheim (DE); Kirsten Markgraf, Weinheim (DE); Ursula Ziegler, Mainz-Kostheim (DE)

(21) Appl. No.: 15/915,521

(22) Filed: Mar. 8, 2018

Related U.S. Application Data
(60) Provisional application No. 62/469,746, filed on Mar. 10, 2017.

(51) Int. Cl. C08L 59/02; B66C 23/70; F16C 29/02; F16C 33/20

(52) U.S. Cl. CPC C08L 59/02; B66C 23/707; F16C 29/02; F16C 33/201; B66C 23/701; C08L 2203/00; F16C 2208/22; B66C 2700/0357; F16C 2202/02; F16C 2202/50; F16C 2208/32; F16C 2326/00; F16C 2208/66; C08L 2205/03

(57) ABSTRACT

A tribologically modified polyoxymethylene polymer composition is disclosed. In accordance with the present disclosure, the polyoxymethylene polymer composition contains a tribological modifier, such as polytetrafluoroethylene, in combination with a stabilizer package. The stabilizer package can include a guanamine compound in combination with at least one carboxylic acid salt. The stabilizer package minimizes formaldehyde emission.

### RELATED APPLICATIONS

The present application claims priority to U.S. Provisional Application Ser. No. 62/469,746, filed on Mar. 10, 2017, which is incorporated herein by reference in its entirety.

### BACKGROUND

Polyacetal polymers, which are commonly referred to as polyoxymethylene polymers, have become established as exceptionally useful engineering materials in a variety of applications. For instance, because polyoxymethylene polymers have excellent mechanical properties, fatigue resistance, abrasion resistance, chemical resistance, and moldability, they are widely used in constructing polymer articles, such as articles for use in the automotive industry and the electrical industry.

The mechanical properties of polyoxymethylene molding compositions are the reason for their use in numerous applications. To improve their properties, polyoxymethylene polymers are often provided with additives to adapt the properties for a specific application, for example by using reinforcing fibers or tribological modifiers. For instance, polyoxymethylene polymers have been combined with a tribological modifier for producing polymer compositions well suited for use in tribological applications where the polymer article is in moving contact with other articles, such as metal articles, plastic articles, and the like. These tribological applications can include embodiments where the polymer composition is formed into gear wheels, pulleys, sliding elements, and the like. The addition of a tribological modifier can provide a composition with a reduced coefficient of friction and low wear.

One problem encountered by those skilled in the art when attempting to combine additives, such as tribological additives, with polyoxymethylene polymers is that the additives may have a tendency to increase formaldehyde emissions from the polymer. Thus, problems have been experienced in the past in being able to incorporate relatively great amounts of a tribological additive into a polyoxymethylene polymer and thereby significantly reduce the coefficient of friction characteristics of the polymer without also increasing formaldehyde emissions from the polymer. Thus, those skilled in the art have also attempted to add various different agents, such as formaldehyde scavengers, into polyoxymethylene polymer compositions in order to counteract any increase in formaldehyde emissions that may be caused by the presence of other additives. The various different types of formaldehyde reducing agents, however, have unpredictable properties when combined with various different additives making it difficult to select an appropriate formaldehyde reducing agent in any particular application.

In view of the above, a need exists for a polyoxymethylene polymer composition that has reduced coefficient of friction properties in combination with acceptable formaldehyde emission levels. A need exists, for instance, for a polyoxymethylene polymer composition that includes at least one tribological additive for reducing the coefficient of friction characteristics of the polymer while also containing a suitable stabilizer package that counterbalances formaldehyde emissions.

### SUMMARY

According to one embodiment, the present disclosure is directed to a polymer composition. The composition is comprised of a polyoxymethylene polymer combined with a tribological modifier system that produces a polymer composition with excellent low friction characteristics, especially when the polymer composition is tested against metals, such as steel.

The present disclosure is generally directed to a polymer composition containing a polyoxymethylene polymer in conjunction with at least one tribological additive that reduces the coefficient of friction characteristics of the polymer. The present disclosure is also directed to the use of a particular stabilizer package that allows significant amounts of a tribological additive to be incorporated into the polymer without substantially increasing formaldehyde emissions. In one embodiment, the polymer composition contains at least one tribological additive in combination with a stabilizer package while remaining silicone-free.

The polymer composition of the present disclosure has numerous and diverse practical applications and uses. In one embodiment, for instance, the composition can be used to produce sliding surfaces in cranes, such as sliding surfaces contained in articulated arms that are part of a crane.

In one embodiment, for instance, the present disclosure is directed to a polymer composition containing a polyoxymethylene polymer, such as a polyoxymethylene copolymer. The polyoxymethylene polymer can be present in the composition in an amount greater than about 50% by weight, such as in an amount greater than about 60% by weight, such as in an amount greater than about 70% by weight and generally in an amount less than about 95% by weight, such as in an amount less than about 90% by weight, such as in an amount less than about 85% by weight. In accordance with the present disclosure, the polyoxymethylene polymer is combined with at least one tribological additive. The tribological additive can comprise a fluoropolymer, such as polytetrafluoroethylene. In one embodiment, for instance, the tribological additive comprises polytetrafluoroethylene particles. The particles can have a mean particle diameter of from about 1 micron to about 10 microns, such as from about 3 microns to about 10 microns, when tested according to ISO Test 13321. The tribological additive can be present in the polymer composition in an amount greater than about 5% by weight, such as in an amount greater than about 8% by weight. The tribological additive is generally present in an amount less than about 30% by weight, such as in an amount less than about 25% by weight, such as in an amount less than about 20% by weight.

In addition to the tribological additive, the polymer composition contains a stabilizer package that is intended to prevent the release of formaldehyde and/or reduce formaldehyde emissions from the composition. The stabilizer package comprises the combination of a benzoguanamine with at least one carboxylic acid salt. The carboxylic acid salt, for instance, may comprise a citrate salt, a stearate salt, or mixtures thereof. In one embodiment, the carboxylic acid salt comprises a calcium salt of a carboxylic acid. Particular examples of carboxylic acid salts that may be used include tricalcium citrate, calcium 12-hydroxystearate, or mixtures thereof. The benzoguanamine and the carboxylic acid salt can be present in the polymer composition generally in an amount from about 0.05% to about 2% by weight, such as from about 0.1% to about 1% by weight.

Polymer compositions made according to the present disclosure can exhibit low formaldehyde emissions. For instance, when tested according to Test VDA 275 after 24 hours using plaques having a thickness of 2 mm, the polymer composition can exhibit a formaldehyde emission of less than about 80 ppm, such as less than about 70 ppm, such as less than about 60 ppm, such as less than about 50 ppm, such as less than about 40 ppm, such as less than about 30 ppm, such as less than about 20 ppm, even when the composition contains the tribological additive in amounts greater than about 8% by weight, such as in amounts greater than about 15% by weight.

The tribological additive can also dramatically reduce the coefficient of friction of the polymer composition when tested against many materials, such as steel. For instance, the polymer composition can display a dynamic coefficient of friction of less than about 0.25, such as less than about 0.2, such as less than about 0.17, such as less than about 0.15, such as less than about 0.13 when tested against steel. In addition, the polymer composition can exhibit a wear track depth when tested against steel of less than about 1 micron, such as less than about 0.8 microns, such as less than about 0.6 microns. The dynamic coefficient of friction can be tested according to VDA Test 230-206. During the VDA 230-206 Test, a ball-on-plate configuration is used. A steel ball is used having an R_{z} of 5 microns. The force used is 30 N and the velocity is 150 mm/s. Results are obtained after 5,000 cycles of testing. The movement is oscillating. The output of the VDA 230-206 Test is static coefficient of friction, dynamic coefficient of friction, and abrasion width of the system. In addition, the wear track depth can be measured using any suitable depth sensing device that is accurate to hundredths of a micron.

In one embodiment, the polyoxymethylene polymer incorporated into the polymer composition has a relatively low viscosity. For instance, the polyoxymethylene polymer can have a melt flow rate of less than about 5 cm³ per 10 min, such as less than about 2 cm³ per 10 min, such as even less than 1.5 cm³ per 10 min. The melt volume rate is measured according to ISO Test 1133 at a temperature of 190° C. and at a load of 2.16 kg.

In one embodiment, the polymer composition only contains one tribological additive and does not contain any further tribological modifiers, such as a silicone. In addition to the tribological additive, the polymer composition may contain various other components. For instance, the composition can also contain a nucleant. The polymer composition can also contain one or more coloring agents. The coloring agents can be present in the composition in an amount from about 0.3% to about 2% by weight. Coloring agents that may be present in the composition include titanium dioxide, carbon black, a pigment such as a yellow pigment or a green pigment, and mixtures thereof. In one embodiment, the polymer composition contains a mixture of titanium dioxide, carbon black, and at least one other pigment, such as a combination of a yellow and a green pigment.

In addition to having low formaldehyde emission characteristics and excellent sliding characteristics, the polymer composition can also have excellent strength properties. For instance, even when the polymer composition contains at least 8% by weight polytetrafluoroethylene, the polymer composition can have a tensile modulus of greater than about 2,000 MPa, such as greater than about 2,200 MPa when tested according to ISO Test 527-2/1A. In addition, the polymer composition can have a Charpy notched impact strength of greater than about 6 kJ/m², such as greater than about 6.4 kJ/m² when tested according to ISO Test 179/1eU.

The polymer composition of the present disclosure is particularly well suited for producing sliding members that are intended to contact metallic components or products. For example, the polymer composition of the present disclosure is well suited to producing sliding surfaces used in an articulated arm of a crane. For instance, a crane can include a telescopic boom comprising an inner arm contained within an outer arm. The inner arm can be movable relative to the outer arm such that the inner arm can extend and retract from the outer arm. The boom can include at least one sliding surface made from the polymer composition of the present disclosure. The sliding surface, for instance, may be configured to engage a metallic member, such as a steel member that slides across the sliding surface during movement of the arm. The sliding surface, for instance, can be part of a bearing, such as a bushing bearing.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of an articulated arm of a crane made in accordance with the present disclosure.

Repeat use of reference characters in the present specification and drawings is intended to represent the same or analogous features or elements of the present invention.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

In general, the present disclosure is directed to a polyoxymethylene polymer composition and to polymer articles made from the composition. The polymer composition contains a polyoxymethylene polymer and has improved tribological properties such as excellent low friction characteristics, especially when tested against a metal such as steel. In addition, the polymer composition can be formulated so as to have dramatically reduced formaldehyde emissions even when containing significant amounts of a tribological additive.

In the past, problems have been experienced in producing wear resistant materials containing one or more tribological additives without increasing formaldehyde emissions. In this regard, the present disclosure is directed to a polyoxymethylene polymer composition containing significant amounts of a tribological additive in order to dramatically reduce the friction characteristics of the polymer composition without compromising the formaldehyde emission characteristics of the polymer.

In one embodiment, the polymer composition comprises a polyoxymethylene polymer combined with a tribological additive and a specially selected stabilizer package that counteracts the impact the tribological additive can have on formaldehyde emissions. The tribological additive, for instance, may comprise a fluoropolymer. The stabilizer package, on the other hand, can comprise the combination of a benzoguanamine with at least one carboxylic acid salt.

In general, any suitable polyoxymethylene polymer may be incorporated into the polymer composition.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.01 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

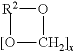

in which x is 0 or 1 and R² is a C₂-C₄ -alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.01 to 5 mol. %, such as from 0.5 to 4 mol. %, of one of the above-mentioned comonomers. In one embodiment, the polyoxymethylene polymer contains relatively low amounts of comonomer. For instance, the comonomer can be present in an amount less than about 2 mol. %, such as less than about 1.5 mol. %, such as less than about 1 mol. %, such as less than about 0.8 mol. %, such as less than about 0.6 mol. %.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal positions. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to or instead of the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer can be produced using a cationic polymerization process followed by solution hydrolysis to remove any unstable end groups. During cationic polymerization, a glycol, such as ethylene glycol or methylal can be used as a chain terminating agent. A heteropoly acid, triflic acid or a boron compound may be used as the catalyst.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally have a melt flow index (MFl) ranging from about 0.1 to about 50 g/10 min, as determined according to ISO 1133 at 190° C. and 2.16 kg, though polyoxymethylenes having a higher or lower melt flow index are also encompassed herein. For example, the polyoxymethylene polymer may have a relatively low melt flow index such as less than about 5 cm³/10 min, such as less than about 3 cm³/10 min, such as less than about 2 cm³/10 min, such as less than about 1.8 cm³/10 min, such as less than about 1.5 cm³/10 min, such as less than about 1.4 cm³/10 min. The melt flow index is generally greater than about 0.5 cm³/10 min, such as greater than about 0.8 cm³/10 min.

Suitable commercially available polyoxymethylene polymers are available under the trade name Hostaform® (HF) by Celanese.

The polyoxymethylene polymer may be present in the polyoxymethylene polymer composition in an amount of at least 50 wt. %, such as at least 60 wt. %, such as at least 70 wt. %, such as at least 80 wt. %, such as at least 85 wt. %, such as at least 90 wt. %, such as at least 93 wt. %. In general, the polyoxymethylene polymer is present in an amount of less than about 100 wt. %, such as less than about 99 wt. %, such as less than about 97 wt. %, wherein the weight is based on the total weight of the polyoxymethylene polymer composition.

According to the present disclosure, the polyoxymethylene polymer is combined with at least one tribological additive. The tribological additive comprises a fluoropolymer, such as a polytetrafluoroethylene powder. The polytetrafluoroethylene particles, for instance, can have an average particle size of less than about 15 microns, such as less than about 12 microns, such as less than about 10 microns, such as less than about 8 microns. The average particle size of the polytetrafluoroethylene particles is generally greater than about 0.5 microns, such as greater than about 1 micron, such as greater than about 2 microns, such as greater than about 3 microns, such as greater than about 4 microns, such as greater than about 5 microns. Average particle size can be measured according to ISO Test 13321.

In one embodiment, the polytetrafluoroethylene particles can have a relatively low molecular weight. The polytetrafluoroethylene polymer may have a density of from about 300 g/l to about 450 g/l, such as from about 325 g/l to about 375 g/l when tested according to ASTM Test D4895. The polytetrafluoroethylene particles can have a specific surface area of from about 5 m²/g to about 15 m²/g, such as from about 8 m²/g to about 12 m²/g when tested according to Test DIN66132. The melt flow rate of the polytetrafluoroethylene polymer can be less than about 3 g/10 min, such as less than about 2 g/10 min when tested according to ISO Test 1133 when carried out at 372° C. with a load of 10 kg.

The polytetrafluoroethylene particles can be present in the polymer composition in an amount greater than about 5% by weight, such as in an amount greater than about 8% by weight, such as in an amount greater than about 10% by weight, such as in an amount greater than about 15% by weight. The polytetrafluoroethylene polymer is generally present in the polymer composition in an amount less than about 40% by weight, such as in an amount less than about 30% by weight, such as in an amount less than about 25% by weight, such as in an amount less than about 23% by weight. In one embodiment, the polytetrafluoroethylene particles are present in the composition in an amount from about 5% to about 17% by weight, such as in an amount from about 8% to about 15% by weight. For instance, in certain embodiments, it has been discovered that the polyoxymethylene composition is more wear resistant when the polytetrafluoroethylene particles are present in amounts less than about 17% by weight, such as in amounts less than about 15% by weight, such as in amounts less than 12% by weight. In other embodiments, however, it may be more desirable to have greater amounts of the polytetrafluoroethylene particles.

According to the present disclosure, the tribological additive improves the tribological properties of the polyoxymethylene polymer compositions and polymer articles produced therefrom without the need for an external lubricant, such as water-based external lubricants, when utilized in tribological applications. An external lubricant may be a lubricant that is applied to a polymer article or polyoxymethylene based system of the present disclosure. In one embodiment, an external lubricant may not be associated with the polyoxymethylene polymer composition or polymer article such that the external lubricant is not present on a surface of the polyoxymethylene polymer composition or polymer article. In another embodiment, an external lubricant may be utilized with the polyoxymethylene polymer composition and polymer article of the present disclosure.

In addition to a polyoxymethylene polymer and a tribological additive, the polymer composition of the present disclosure further contains a stabilizer package that is intended to prevent the release of formaldehyde and/or reduce formaldehyde emissions from the composition. The stabilizer package contains a guanamine compound. The guanamine compound may include an aliphatic guanamine-based compound, an alicyclic guanamine-based compound, an aromatic guanamine-based compound, a hetero atom-containing guanamine-based compound, or the like. In one embodiment, the guanamine compound comprises a benzoguanamine. The guanamine compound can be present in the polymer composition in an amount of at least about 0.05% by weight, such as in an amount of at least about 0.1% by weight, such as in an amount of at least about 0.3% by weight, such as in an amount of at least about 0.5% by weight. The guanamine compound is generally present in the composition in an amount less than about 2% by weight, such as in an amount less than about 1.5% by weight, such as in an amount less than about 1% by weight.

In addition to a guanamine compound, the polymer composition further contains at least one carboxylic acid salt. For instance, the carboxylic acid salt may comprise a salt of a fatty acid, such as a metal salt of a fatty acid. For example, the carboxylic acid salt may comprise an alkaline earth metal salt of a fatty acid. The cation of the salt, for instance, may comprise calcium, barium, lithium, sodium, magnesium, zinc, or the like.

The fatty acid can contain a carbon chain of generally from about 3 carbon atoms to about 20 carbon atoms. The fatty acid may comprise a dicarboxylic acid or a tricarboxylic acid.

In one embodiment, the metal salt of the fatty acid may comprise a metal salt of citric acid, propionic acid, stearic acid, butanoic acid, hexanoic acid, decanoic acid, lauric acid, myristic acid, palmitic acid, and the like. In one particular embodiment, the metal salt of the fatty acid may comprise calcium propionate, calcium 12-hydroxystearate, a calcium citrate such as tricalcium citrate, and mixtures thereof.

One or more carboxylic acid salts are generally present in the polymer composition in an amount greater than about 0.05% by weight, such as in an amount greater than about 0.1% by weight, such as in an amount greater than about 0.2% by weight, such as in an amount greater than about 0.3% by weight, such as in an amount greater than about 0.4% by weight, such as in an amount greater than about 0.5% by weight. One or more carboxylic acid salts are generally present in the polymer composition in an amount less than about 5% by weight, such as in an amount less than about 3% by weight, such as in an amount less than about 2% by weight, such as in an amount less than about 1.5% by weight, such as in an amount less than about 1% by weight.

The polymer composition of the present disclosure may also contain other known additives such as, for example, antioxidants, UV stabilizers or heat stabilizers, reinforcing fibers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a coloring agent may be present. Coloring agents that may be used include any desired inorganic pigments, such as titanium dioxide, ultramarine blue, cobalt blue, and other organic pigments and dyes, such as phthalocyanines, anthraquinnones, and the like. Other coloring agents include carbon black or various other polymer-soluble dyes. In one embodiment, a combination of coloring agents may be included in the polymer composition. For instance, the polymer composition may contain titanium dioxide in combination with carbon black. In an alternative embodiment, the coloring agents present in the polymer composition may comprise titanium dioxide in combination with at least one color pigment, such as a yellow pigment and a green pigment and optionally further in combination with carbon black. The coloring agent may be present in the composition in an amount of at least about 0.01 wt. %, such as at least about 0.05 wt. %, such as at least about 0.1 wt. %, such as at least about 0.5 wt. %, such as at least about 0.8 wt. %, such as at least about 1 wt. % and less than about 5 wt. %, such as less than about 2.5 wt. %, such as less than about 1 wt. %, wherein the weight is based on the total weight of the respective polymer composition.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

Polymer articles include any moving articles or moldings that are in contact with another surface and may require high tribological requirements. For instance, polymer articles include articles for the automotive industry, especially housings, latches such as rotary latches, window winding systems, wiper systems, pulleys, sun roof systems, seat adjustments, levers, bushes, gears, gear boxes, claws, pivot housings, wiper arms, brackets or seat rail bearings, zippers, switches, cams, rollers or rolling guides, sliding elements or glides such as sliding plates, conveyor belt parts such as chain elements and links, castors, fasteners, levers, conveyor system wear strips and guard rails, medical equipment such as medical inhalers and injectors. An almost limitless variety of polymer articles may be formed from the polymer compositions of the present disclosure.

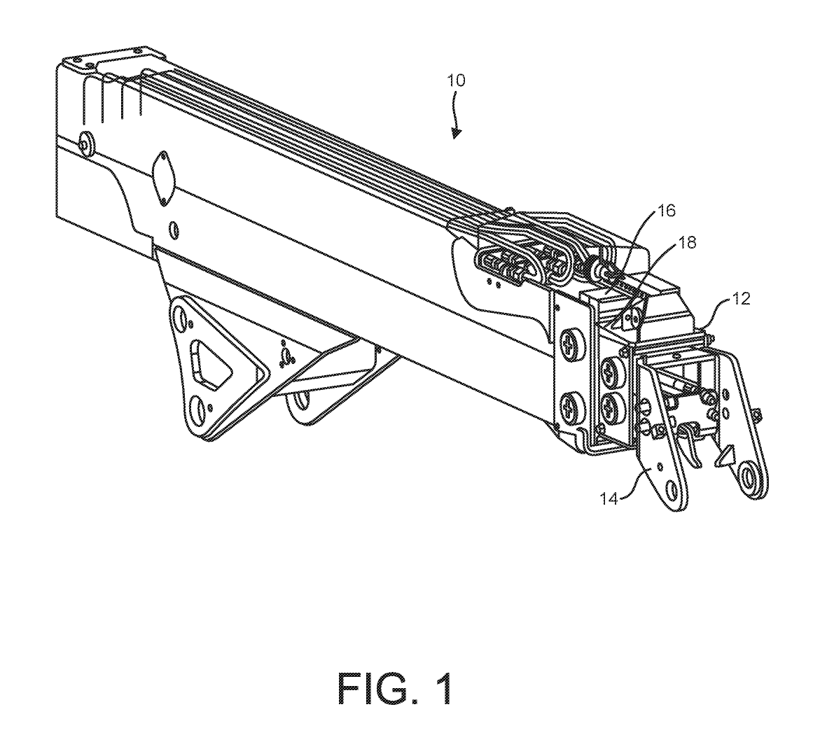

In one embodiment, polymer articles made in accordance with the present disclosure can be used to make components of an articulated arm on a crane. The crane, for instance, can be mounted on a crane truck. For instance, referring to FIG. 1, one embodiment of a telescopic boom arrangement of an articulated arm for a crane is shown. The telescopic boom arrangement includes an articulated arm 10, an extendable crane-side outer arm 12 and a further extendable end-side inner arm 14. The inner arm 14 is movable in relation to the outer arm 12. For instance, the inner arm 14 can extend and retract within the outer arm 12. The telescopic boom arrangement can include hydraulic motors and conduits that can be controlled for moving one arm relative to the other.

In accordance with the present disclosure, the articulated arm 10 further includes a bearing 18 that is associated with a bearing housing 16. As shown in FIG. 1, the bearing 18 is located at the end region of the articulated arm 10. The bearing 18 is a sliding bearing that facilitates movement of the outer arm 12 and/or inner arm 14.

The bearing 18 includes a sliding surface. The sliding surface is a low friction surface that allows one of the arms to slide relative to the other arm. The sliding surface, for instance, contacts metal rails on an opposing surface so that the arms can move relative to one another in a facilitated manner. In accordance with the present disclosure, the sliding surface of the bearing 18 can be made from the polyoxymethylene polymer composition as described above.

In addition to the sliding surface within the bearing 18, the articulated arm 10 may also include a chain member that causes the inner arm to extend or retract from the outer arm. The chain member can be associated with a bushing bearing that also can include a sliding surface as described above. The sliding surface of the bushing bearing can engage a metallic member and allow the metallic member to contact and slide across the sliding surface when the chain member is engaged and the inner arm 14 is moved relative to the outer arm 12. The sliding surface can be made from the polymer composition of the present disclosure. When producing sliding surfaces with articulated arms, the polymer composition can be formulated to be silicone-free while still having low friction characteristics and low formaldehyde emission properties.

Utilizing the polyoxymethylene polymer composition and polymer article produced therefrom according to the present disclosure provides compositions and articles with improved tribological properties. According to the present disclosure, the tribological properties are generally measured by the coefficient of friction.

In general, static friction is the friction between two or more surfaces that are not moving relative to each other (i.e., both objects are stationary). In general, dynamic friction occurs when two objects are moving relative to each other (i.e., at least one object is in motion or repeated back and forth motion). In addition, stick-slip is generally known as a phenomenon caused by continuous alternating between static and dynamic friction.

According to the present disclosure, the composition and polymer article may exhibit a dynamic coefficient of friction against steel, as determined according to VDA 230-206, of generally less than about 0.25, such as less than about 0.2, such as less than about 0.17, such as less than about 0.15. The dynamic coefficient of friction is generally greater than 0. The above dynamic coefficient of friction is measured with a force of 30 N, a velocity of 150 mm/s, and after 5,000 cycles.

Polymer compositions according to the present disclosure when tested against steel may exhibit a depth of wear of less than about 1 micron, such as less than about 0.8 microns, such as less than about 0.6 microns. The depth of wear can be even 0.

While the polyoxymethylene polymer composition and polymer articles produced therefrom of the present invention provide improved tribological properties, the compositions and articles may also exhibit excellent mechanical properties (ISO Test 527). For example, when tested according to ISO Test No. 527, the polymer composition may have a tensile modulus of greater than about 2,000 MPa, such as greater than about 2,200 MPa. The tensile modulus is generally less than about 10,000 MPa.

The polymer composition can exhibit a notched Charpy impact strength at 23° C. (ISO Test 179-1) of greater than about 6 kJ/m², such as greater than about 6.4 kJ/m². The notched Charpy impact strength is generally less than about 20 kJ/m².

The polymer composition can exhibit a melt volume ratio of from about 0.1 cm³/10 min to about 5 cm³/10 min in certain embodiments. In one embodiment, the melt volume ratio is from about 0.5 cm³/10 min to about 2 cm³/10 min. Melt volume ratio can be measured at 190° C. and at a load of 2.16 kilograms.

The present disclosure may be better understood with reference to the following examples.

### EXAMPLE

In this example, various polymer compositions were formulated and tested for tribological properties, physical properties and formaldehyde emissions.

A polyoxymethylene polymer having a MFI of about 1.5 cm³ per 10 min was tested with multiple combinations of stabilizers and polytetrafluoroethylene (PTFE) to determine a desirably durable and friction-minimal composition. Stabilizer packages tested include tricalcium citrate, benzoguanamine, a copolyamide, calcium hydroxysterate, allantoin, and a blend of a nylon multipolymer resin, an ionomer of ethylene acid acrylate terpolymer, and calcium acetate.

| | Wt.-% in final composition based |
|---|---|
| Stabilizers | on polyoxymethylene polymer |
| Nylon multi-polymer resin | 0.15 |
| (0.05 wt. %), ionomer of | |
| ethylene acid acrylate | |
| terpolymer (0.018 wt. %), | |
| and calcium acetate | |
| (0.002 wt. %) | |
| Tricalciumcitrate | 0.05 |
| Benzoguanamine | 0.5 |
| Copolyamide | 0.05 |
| Ca. 12-hydroxystearate | 0.07 |

The components of each composition were mixed together and compounded using a twin screw extruder (zone temperature 190° C., melt temperature about 210° C.). The screw configuration with kneading elements was chosen so that effective and thorough mixing of the components took place. The compositions were extruded and pelletized. The pellets were dried for 8 hours at 120° C. and then injection molded. The process conditions were selected in accordance with recommendations of ISO-9988-2, material standard for polyoxymethylene. The components were then tested for formaldehyde emissions as 2 mm plaques according to VDA 275 after 24 hours. Additionally, the components were tested for various tensile properties according to ISO-527 by stretching a sample of material between two arms until breakage, and notched and un-notched impact strength by Charpy impact test. One sample of material is notched and another is not, but the process for both involves striking the sample and measuring the energy absorbed by the material until breakage. The results are shown in the table below.

| | | | | | | | | Charpy | Charpy |
|---|---|---|---|---|---|---|---|---|---|
| | | | | | | | | Notched | Un-notched |
| | | VDA 275 | Tensile | Yield | Yield | Stress | Strain | Impact | Impact |
| PTFE | | 2 mm/24 hrs | Modulus | Stress | Strain | at Break | at Break | Strength | Strength |
| wt.-% | Stabilizer package | ppm | MPa | MPa | % | MPa | % | kJ/m² | kJ/m² |
| 0 | Copolyamide + Tricalciumcitrate | 213 | 2744 | 67 | 16.65 | 62 | 52.2 | 10.8 | 255 |
| 0 | Copolyamide + Ca. 12-hydroxystearate | 164 | 2542 | 67.57 | 16.10 | 62.53 | 43.2 | 11.7 | 195 |
| 10 | Copolyamide + Tricalciumcitrate | 135 | 2350 | 60.4 | 17.9 | 59.2 | 29.7 | 5.7 | 113 |
| 10 | Copolyamide + Ca. 12-hydroxystearate | 126 | 2610 | 59.9 | 16.9 | 58.8 | 35.75 | 5.4 | 107 |
| 10 | Benzoguanamine + Tricalciumcitrate | 43 | 2220 | 59.6 | 18.4 | 57.5 | 31.6 | 7 | 149 |
| 10 | Benzoguanamine + Ca. 12-hydroxystearate | 24 | 2250 | 59.3 | 18 | 58 | 30 | 6.5 | 156 |
| 10 | Allantoin + Tricalciumcitrate | 119 | 2288 | 59.9 | 18.65 | 58 | 31.1 | 6.2 | 121 |
| 10 | Allantoin + Ca. 12-hydroxystearate | 118 | 2672 | 59.4 | 17.7 | 58.4 | 37.2 | 5.6 | 128 |
| 10 | Nylon multi-polymer resin + ionomer of | 145 | 2501 | 59.6 | 18.60 | 58.6 | 36 | 6 | 108 |
| | ethylene acid acrylate terpolymer + | | | | | | | | |
| | calcium acetate + Tricalciumcitrate | | | | | | | | |
| 10 | Nylon multi-polymer resin + ionomer of | 151 | 2602 | 59.6 | 16.6 | 58.6 | 34.3 | 5.4 | 118 |
| | ethylene acid acrylate terpolymer + | | | | | | | | |
| | calcium acetate + Ca. 12- hydroxystearate | | | | | | | | |
| 18 | Benzoguanamine + Tricalciumcitrate | 20 | 2055 | 53.7 | 19.60 | 52.4 | 24 | 6.1 | 121 |
| 18 | Benzoguanamine + Ca. 12-hydroxystearate | 15 | 2100 | 54 | 19.5 | 52.2 | 24 | 6.1 | 116 |

As can be seen in the table, testing illustrated that the compositions comprising benzoguanamine with a carboxylic acid salt typically had significantly lower formaldehyde emissions.

Tribological performance was analyzed by using a ball made of modified polyoxymethylene sliding against a steel ball of surface roughness (R_{z}) of 5 microns, using a stick-slip test equipment. Static and Dynamic coefficient of friction as well as system wear, were evaluated at a sliding speed of 150 mm/s and a load of 30N after 5000 cycles of testing. The results are given below in the table.

| | | Dynamic | | POM wear |
|---|---|---|---|---|
| | PTFE | CoF | Static CoF | width (mm) |
| | (wt.-%) | vs. Steel | vs. Steel | vs. Steel |
| POM grade | Steel R_{z} = 5 μm | | | |
| POM | 0 | 0.18 | 0.28 | 1.1 |
| (MFI = 1.5 cm³/10 min) | | | | |
| POM | 10 | 0.12 | 0.2 | 0.4 |
| (MFI = 1.5 cm³/10 min) | | | | |
| POM | 18 | 0.12 | 0.2 | 0.44 |
| (MFI = 1.5 cm³/10 min) | | | | |
| POM | 18 | 0.12 | 0.2 | 0.54 |
| (MFI = 9 cm³/10 min) | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

What is claimed:

1. A polymer composition comprising:
a polyoxymethylene polymer present in the composition in an amount of at least about 50% by weight;
at least one tribological additive comprising a polytetrafluoroethylene polymer, the polytetrafluoroethylene polymer being present in the composition in an amount from about 5% to about 30% by weight;
a benzoguanamine;
a carboxylic acid salt; and
wherein the polymer composition emits less than about 80 ppm of formaldehyde when tested according to Test VDA 275 after 24 hours using a plaque having a width of 2 mm.

2. A polymer composition as defined in claim 1, wherein the polymer composition is silicone free.

3. A polymer composition as defined in claim 1, wherein the composition emits less than about 50 ppm of formaldehyde when tested according to Test VDA 275 after 24 hours using a plaque having a width of 2 mm.

4. A polymer composition as defined in claim 1, wherein the carboxylic acid salt comprises tricalcium citrate, calcium 12-hydroxystearate, or mixtures thereof.

5. A polymer composition as defined in claim 1, wherein the benzoguanamine is present in the composition in an amount from about 0.05% to about 2% by weight.

6. A polymer composition as defined in claim 1, wherein the carboxylic acid salt is present in the composition in an amount from about 0.05% to about 2% by weight.

7. A polymer composition as defined in claim 1, wherein the polymer composition exhibits a wear track width of less than about 0.5 mm when tested against a steel substrate having an R_{z} of 5 microns at a sliding speed of 150 mm/s, at a load of 30 N, and after 5,000 cycles of testing according to Test VDA 230-206.

8. A polymer composition as defined in claim 1, wherein the polymer composition has a dynamic coefficient of friction of less than about 0.16 when tested against a steel substrate having an R_{z} of 5 microns and at a sliding speed of 150 mm/s, at a load of 30 N, and after 5,000 cycles according to Test VDA 230-206.

9. A polymer composition as defined in claim 1, wherein the polytetrafluoroethylene is present in the composition in an amount from about 5% to about 20% by weight.

10. A polymer composition as defined in claim 1, wherein the carboxylic acid salt comprises a citrate or stearate salt.

11. A polymer composition as defined in claim 1, wherein the carboxylic acid salt comprises a calcium salt of a carboxylic acid.

12. A polymer composition as defined in claim 1, wherein the polyoxymethylene polymer has a melt volume rate of less than about 5 cm³ per 10 min when tested according to ISO Test 1133 at 190° C. and at a load of 2.16 kg.

13. A polymer composition as defined in claim 1, wherein the polymer composition contains the polytetrafluoroethylene polymer in an amount of at least 8% by weight and wherein the polymer composition has a tensile modulus of at least 2,000 MPa when tested according to ISO Test 527-2/1A.

14. A polymer composition as defined in claim 1, wherein the polymer composition has a Charpy notched impact strength of greater than about 6 kJ/m² when tested according to ISO Test 179/1eU.

15. An articulated arm on a crane comprising:
a telescopic boom comprising an inner arm contained within an outer arm, the inner arm being movable relative to the outer arm and defining at least one sliding surface, the sliding surface being made from the polymer composition as defined in claim 1.

16. An articulated arm as defined in claim 15, wherein the sliding surface is contained within a bearing.

17. An articulated arm as defined in claim 15, wherein the sliding surface is contained within a bushing bearing associated with a chain member that causes the inner arm to extend and retract from the outer arm.

18. An articulated arm as defined in claim 15, wherein the sliding surface engages a metallic member and wherein the metallic member contacts and slides across the sliding surface when the inner arm is extended or retracted from the outer arm.

19. A crane truck comprising the articulated arm as defined in claim 1.
